(19) United States
(12) Patent Application Publication
(10) Pub. No.: US 2014/0248105 A1
(43) Pub. Date: Sep. 4, 2014

(54) WALL MOUNTING DEVICE

(71) Applicant: Tadashi Namekawa, Chiba (JP)

(72) Inventor: Tadashi Namekawa, Chiba (JP)

(73) Assignee: Fumio SUDOH, Mitaka-shi, Tokyo (JP)

(21) Appl. No.: 14/127,234

(22) PCT Filed: Jun. 18, 2012
(86) PCT No.: PCT/JP2012/066094

§ 371 Date: Mar. 13, 2014

(30) Foreign Application Priority Data
Jun. 18, 2011 (JP) 2011-135827
Mar. 8, 2012 (JP) 2012-052375

(51) Int. Cl. F16B 19/00

(52) U.S. Cl. CPC F16B 19/00
USPC 411/500

(57) ABSTRACT

The present invention provides a wall mounting device that can be driven accurately and reliably into a wall, even if the wall is a hard wall such as a concrete wall.

The wall mounting device is equipped with a needle member 11 that is driven into a wall and a head member 12 that is thereby mounted to the wall. The needle member 11 is equipped with at least one plate-shaped pin, i.e., elongate plate-shaped pins 14, 15, that includes pointed end sections 21, 22 and is formed relatively thin overall. In the plate-shaped pins 14, 15, the force received when the pins are driven into the wall is concentrated at the end sections 21, 22, thus allowing the pins to be easily driven into the wall. In addition, the pins are formed with thin, narrow, and plate-shaped cross-sections, thus reducing the deformation and dislocation of the wall material when the pins are driven into the wall. As a result, damage to the wall is minimized. After being driven in, the wall supports the plate-shaped pins 14, 15 from both sides, providing firm support for the wall mounting device. The object to be attached to the wall is hung on the wall by being directly engaged with the head member 12 or by being indirectly engaged by way of an engagement piece secured to the head member 12.

### TECHNICAL FIELD

The present invention relates to a wall mounting device that is used on walls of buildings such as residences to hook different types of objects, e.g., furniture such as shelves and boxes, devices such as clocks and air conditioners, and decorative items such as paintings and sculptures.

### BACKGROUND TECHNOLOGY

In standard residences and the like, objects such as shelves and storage cases, and mirrors and picture frames have been attached to walls formed from wood such as veneer panels, plasterboard, concrete, or the like. An example of a structure used to attach objects of this type to walls is a structure wherein a pin is secured to the wall material and the object is hooked onto the secured pin. The object is simply hooked to the pin and the attachment tools or devices do not stick out from the object, therefore this type of hook structure is attractive. Furthermore, the object can be easily removed from the wall by simply unhooking the object from the pin.

When hooking an object to a wall using a pin in this manner, the load that the wall can support depends on the type of wall material involved. Thus, the type and quantity of pins to be used is determined on the basis of the type of wall as well as the weight of the object.

Patent Document 1 discloses an example of a mounting device in which a pin for hooking an object to a wall is mounted to a wall surface. This mounting device is a thumbtack-shaped pin which is equipped with a pin head section and a pin needle section that extends from the pin head section. An engagement member is attached to the object to be attached to the wall. The thumbtack-shaped pin is attached to the wall by driving in the pin needle section into the wall, and the engagement member engages with the pin by cradling the pin head section. The engagement between the engagement member and the thumbtack-shaped pin allows the object to be attached to the wall.

If the object to be attached is light, the pin can be formed as a needle that is pushed into the wall. If the object is heavy, however, a nail or a threaded screw is used instead of a needle. The pin is attached to the wall by driving the nail into the wall or by screwing the screw into the wall.

When removing an object that was hooked to a wall, e.g., when remodeling a room or when a tenant moves out, the pin used to hook the object is generally removed from the wall as well. With walls made from concrete, as is often found in rental apartments, wood such as veneer panels, or plasterboard, removing a pin driven into the wall leaves a large hole in the wall where the pin was mounted. Such large holes may diminish the appearance and value of the room. Repairing these holes is time consuming and repairing holes inexpensively and so that they are not visible is extremely difficult.

In addition, for wall-mounted pins that are driven into hard walls such as concrete walls, the pin must be driven in with a force that is greater than the strong resistance provided by the wall. However, it is difficult to keep the pin driven in while maintaining a proper attitude of the pin to the hard wall with such great force. More specifically, at the start of and during the driving in of the pin, the driving pin itself can become deformed or the attitude of the pin can easily change. If the driving pin itself becomes deformed or the attitude of the pin changes, the driving pin cannot be attached with a correct direction to the wall, leading to drawbacks such as the driving pin tending to fall out from the wall.

### BACKGROUND TECHNOLOGY DOCUMENTS

### Patent document

Patent Document 1: Japanese Laid-open Patent Publication Number Hei 10-151061

### SUMMARY OF THE INVENTION

### Problems to be Solved by the Invention

Thus, a problem to be solved is to provide a wall mounting device that is equipped with a needle member that is driven into a wall and a head member to which a base section of the needle member is secured, and that hooks an object to a wall by engaging the object to an engagement piece secured to the wall mounting device, wherein the shape/structure of the needle member is devised to allow the needle member to be easily and reliably driven into even hard walls such as concrete walls while maintaining a stable orientation.

The object of the present invention is to overcome this problem and to provide a wall mounting device that allows a needle member to be accurately and reliably driven into walls that are relatively hard, e.g., concrete walls as well as walls that are relatively soft.

### Means for Solving the Problems

In order to overcome the problem described above and to achieve the object described above, a wall mounting device according to the present invention is equipped with a needle member and a head member with which the needle member is combined so that the needle member is outwardly projected from the head member, the needle member being driven into a wall so that the head member is mounted on the wall, wherein the needle member is equipped with at least one elongate plate-shaped pin with a pointed end section.

With this wall mounting device, the needle member, unlike standard pins with circular cross sections, is formed with a long, narrow plate-shaped pin that is relatively thin and that has a pointed end section. As a result, the driving force that is received when the pin is driven into a wall is concentrated at the end section, allowing the pin to be easily driven into hard walls. More specifically, the plate-shaped pin has a thin, narrow, plate-shaped cross-section so that deformation and displacement of the wall is minimized when the pin is driven in, unlike when driving a pin with a circular cross section and a large diameter is driven into a wall. As a result, the resistance which the pin receives from the wall is weak, making the pin easier to drive in. In addition, the damage to the wall can be reduced as well. After the pin is driven in, the wall supports the plate-shaped pin from both sides, resulting in the wall mounting device being mom firmly supported in the wall.

According to a specific aspect, there is provided a wall mounting device wherein: the needle member is formed to be driven through the head member and into the wall; and the head member is formed with a support/guide groove that supports the combined needle member and that guides the motion of the needle member when the needle member is driven from the supported state through the head member and into the wall. With this wall mounting device, the needle member can be supported in the support/guide groove when the needle member is combined with the head member, and the wall mounting device can be set up in this state when preparing to drive the needle member into a wall or when packaging the wall mounting device for sale. In addition, when the needle member is driven through the head member and into the wall, the needle is guided by the support/guide groove, thus allowing the needle member to be driven into the wall in a stable manner without buckling.

According to another specific aspect, there is provided a wall mounting device wherein the head member is formed with a pin guide hole that is part of the support/guide groove and that guides the plate-shaped pin during motion of the needle member. By forming the head member ahead of time with the pin guide hole for guiding the plate-shaped pin, the motion of the plate-shaped pin can be guided by the pin guide hole when the plate-shaped pin is pushed into the head member or driven into the wall. This prevents the plate-shaped pin from buckling and provides smooth motion relative to the head member. There is also provided a wall mounting device wherein: a thin wall seals an end of the support/guide groove of the head member toward the direction of motion of said needle member as it is pushed in; and when the needle member is driven through the head member, a hole that subsequently guides the plate-shaped pin is formed on the thin wall by said needle member. In this case, the needle member is inserted into the head member while being guided by the support/guide groove, thus allowing the hole to be formed accurately in relation to the plate-shaped pin. Furthermore, the needle member is guided by the hole formed in this manner so that the needle member can be reliably pushed into the head member or driven into the wall.

According to another specific aspect, there is provided a wall mounting device in which the needle member is pushed into the head member wherein the head member is provided with a stopper section that blocks motion of the needle member in the direction in which the needle member is pushed in. With this wall mounting device, the deepest position that the needle member can reach when the needle member is driven into the wall is automatically determined by the stopper section. As a result, the needle member is prevented from moving further in the driving direction and is prevented from being driven in to a depth greater than a predetermined depth.

According to another specific aspect, there is provided a wall mounting device wherein the needle member is secured to the head member using a slip prevention pin, thereby preventing the needle member from slipping out from the head member. With this wall mounting device, the needle member pushed into the head member is prevented from slipping out from the head member. There is further provided a wall mounting device wherein holes for the slip prevention pin are formed in the needle member and the head member; the holes become aligned when the needle member is pushed into the head member, and the slip prevention pin inserted into the holes of the needle member and the head member when the needle member is pushed into the head member prevents the needle member from slipping out of the head member.

According to another specific aspect, there is provided a wall mounting device wherein a cap that covers a back surface of the needle member is mounted to the head member when the needle member has been driven through the head member. By mounting the cap on the head member, the needle member is prevented from being visible on the surface, thus improving the appearance of the wall mounting device. In addition, an object to be hooked to the wall can be engaged with this cap.

According to another specific aspect, there is provided a wall mounting device that is equipped with this needle member and this head member wherein: the head member is formed from resin; and the needle member is secured to the head member as a result of insert molding. When the needle member and the head member are to be secured to each other, by performing insert molding with the needle member when forming the head member from resin, the wall mounting device is allowed to be produced in an efficient manner. When insert molding, a resin inlet opening can be formed on the needle member. The setting of the resin that flows into the resin inlet opening during insert molding secures the needle member in a strong and reliable manner.

According to another specific aspect, there is provided a wall mounting device wherein the plate-shaped pins with pointed end sections of the needle member share a base section and are formed as at least two parallel pins arranged along a single plane. By forming the plate-shaped pins of the needle member as at least two pins formed parallel to each other and arranged on a single plane allows needle members to be mass produced inexpensively through sheet metal processing, e.g., by die cutting from a single sheet of material. When the wall mounting device is driven into a wall, a plurality of plate-shaped pins are driven into the wall, thus providing a strong securing force between the needle member and the wall. This allows heavy wall-mounted objects to be mounted on the wall in a reliable manner.

According to another specific aspect, there is provided a wall mounting device wherein a rib is formed on a surface of an elongate and flat plate of the plate-shaped pin, the rib extending along a longitudinal axis of the plate-shaped pin. By forming a rib in this manner on the surface of an elongate plate-shaped pin, the plate-shaped pin is more resistant to bending and buckling when the needle member is driven into a wall. There is further provided a wall mounting device wherein the plate-shaped pin is formed with a uniform thickness from the base section to the end section, with a uniform thickness from the base section to right up to the end section with the thickness gradually decreasing at the end section to form a triangular point, or with a thickness that gradually decreases when going from the base section to the end section. Since the plate-shaped pin is shaped to be pointed at the end section, the plate-shaped pin can be driven into hard walls such as concrete walls even when the base section side is formed with a uniform thickness. However, by forming the plate-shaped pin with a thickness that gradually decreases when going from the base section to the end section, the plate-shaped pin can be more easily driven into hard walls.

According to another specific aspect, there is provided a wall mounting device wherein the plate-shaped pin is extended with a diagonal slope relative to the head member. In this case, it would be preferable for the plate-shaped pin to be sloped so that the end of the plate-shaped pin extends diagonally downward when driven into the wall. By forming the plate-shaped pin so that it extends diagonally downward, the application of the weight of the object, e.g., furniture, to the wall mounting device causes the wall mounting device to receive a force in a direction that thrusts the wall mounting device to the wall, thus preventing slippage from the wall. Various configurations can be used to allow the plate-shaped pin to be inserted through, supported by, and guided in the head member.

According to another specific aspect, there is provided a wall mounting device in which the plate-shaped pin extends diagonally from the head member in this manner wherein the needle member is either a straight needle member that is formed with no bend in the plate-shaped pin and that is extended with a diagonal slope relative to the head member, or an angled needle member that is formed with a bend at an intermediate position along the longitudinal axis of the plate-shaped pin, the bent section being extended with a diagonal slope relative to the head member. In either case, the section of the needle member that is projected out from the head member extends diagonally from the head member.

According to another specific aspect, there is provided a wall mounting device in which the plate-shaped pin extends diagonally from the head member wherein the head member is provided with an assisting unit that includes an end surface that corrects the shape of the head member on the basis of a slope angle of the plate-shaped pin, said end surface being perpendicular to a direction in which the plate-shaped pin extends. With this configuration, the driving force acting on the end surface of the assisting unit acts on the plate-shaped pin in the direction in which the plate-shaped pin extends, thus allowing the plate-shaped pin to be easily driven into the wall.

According to another specific aspect, the wall mounting device described is used by being either driven in with the plate-shaped pin at a direction that is perpendicular to the wall or driven in with the plate-shaped pin being sloped relative to the wall and with the head member not being sloped relative to the wall.

According to another specific aspect, there is provided a wall mounting device wherein a plurality of slip prevention ribs is formed on an end surface of the assisting unit to which a pressing force is applied when the wall mounting device is driven into the wall. This type of slip prevention can be achieved with parallel rib shapes or the like.

According to another specific aspect, there is provided a wall mounting device wherein, when actually hooking a wall-mounted object to a wall: a wall-mounted object is directly engaged to the head member; or the wall-mounted object is indirectly engaged to the head member by way of a securing piece that is secured to the head member.

### Advantages of the Invention

A wall mounting device according to the present invention is equipped with a needle member and a head member with which the needle member is combined so that the needle member is outwardly projected from the head member, the needle member being driven into a wall so that the head member is mounted on the wall, wherein the needle member is equipped with at least one elongate plate-shaped pin with a pointed end section. As a result, the driving force that is received when the pin is driven into a wall is concentrated at the end section, allowing the pin to be easily driven into hard walls. More specifically, the plate-shaped pin has a thin, narrow, plate-shaped cross-section so that deformation and displacement of the wall is minimized when the pin is driven in, unlike when driving a pin with a circular cross section and a large diameter is driven into a wall. As a result, the resistance which the pin receives from the wall is weak, making the pin easier to drive in. In addition, the damage to the wall can be reduced as well. After the pin is driven in, the wall supports the plate-shaped pin from both sides, resulting in the wall mounting device being more firmly supported in the wall. Thus, a wall mounting device is provided wherein a needle member can be accurately and reliably driven into any type of wall.

In addition, when the head member is formed with a support/guide groove that supports the needle member combined with the head member and that guides the movement of the needle member as the needle member, starting from this supported state, is pushed through the head member and driven into a wall, the needle member is guided by the support/guide groove as it is driven into the wall. As a result, the needle member is driven into the wall in a stable and reliable manner while maintaining a correct orientation.

Furthermore, when the plate-shaped pin extends diagonally from the head member, setting up the plate-shaped pin so that the end of the plate-shaped pin extends diagonally downward when the wall mounting device is driven into the wall, which results in the wall mounting device being drawn tightly against the wall by the weight of an object, e.g., furniture applied to the wall mounting device. As a result, the wall mounting device is prevented from easily slipping out from the wall and the head member is prevented from easily slipping away from the plate-shaped pin.

Thus, while the specific configuration will be determined according to the material of the wall, the present wall mounting device can be driven into the wall accurately and reliably while maintaining a stable orientation, with failures during the driving operation being minimized.

### BRIEF DESCRIPTION OF THE DRAWINGS

FIG. 1 Drawings showing a first embodiment of a wall mounting device according to the present invention.

FIG. 2 Drawings showing a needle member used in the wall mounting device shown in FIG. 1.

FIG. 3 Drawings showing a head member used in the wall mounting device shown in FIG. 1.

FIG. 4 Drawings showing a cap used in the wall mounting device shown in FIG. 1.

FIG. 5 Drawings showing the procedure for using the wall mounting device shown in FIG. 1.

FIG. 6 Drawings showing a second embodiment of a wall mounting device according to the present invention.

FIG. 7 Drawings showing a needle member used in the wall mounting device shown in FIG. 6.

FIG. 8 Drawings showing a head member used in the wall mounting device shown in FIG. 6.

FIG. 9 Drawings showing a cap used in the wall mounting device shown in FIG. 6.

FIG. 10 Drawings showing a third embodiment of a wall mounting device according to the present invention.

FIG. 11 Drawings showing a fourth embodiment of a wall mounting device according to the present invention.

FIG. 12 Drawings showing a fifth embodiment of a wall mounting device according to the present invention.

FIG. 13 Drawings showing a sixth embodiment of a wall mounting device according to the present invention.

FIG. 14 Drawings showing one usage of a seventh embodiment, in which one portion of the wall mounting device shown in FIG. 13 is modified.

FIG. 15 Drawings showing another usage of the wall mounting device shown in FIG. 14.

FIG. 16 Drawings showing an eighth embodiment of a wall mounting device according to the present invention.

FIG. 17 Drawings showing the details of a mounting assistance tool used to mount a wall mounting device according to the present invention to a wall.

FIG. 18 Drawings illustrating an alternative example of the eighth embodiment shown in FIG. 16.

FIG. 19 Drawings illustrating an alternative example of the seventh embodiment shown in FIG. 14 and FIG. 15.

FIG. 20 Drawings showing another alternative example of the seventh embodiment shown in FIG. 14 and FIG. 15.

FIG. 21 A drawing showing an example of the use of a wall mounting device.

### EMBODIMENTS OF THE INVENTION

The embodiments of the wall mounting device according to the present invention will be described using the drawings.

### First Embodiment

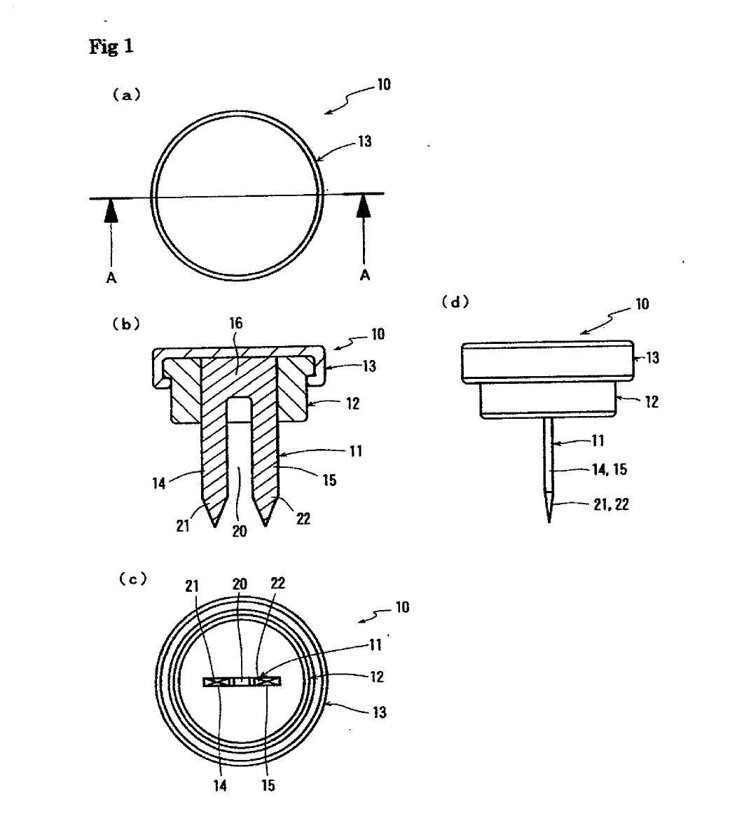

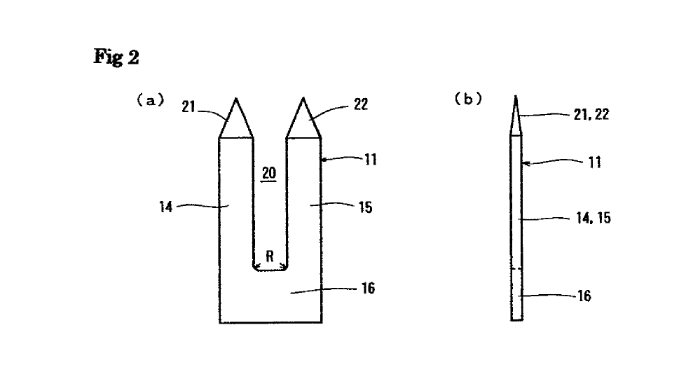

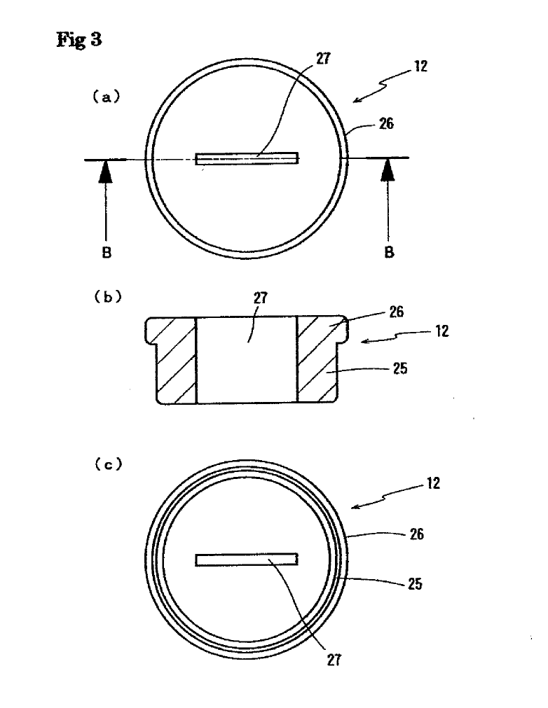

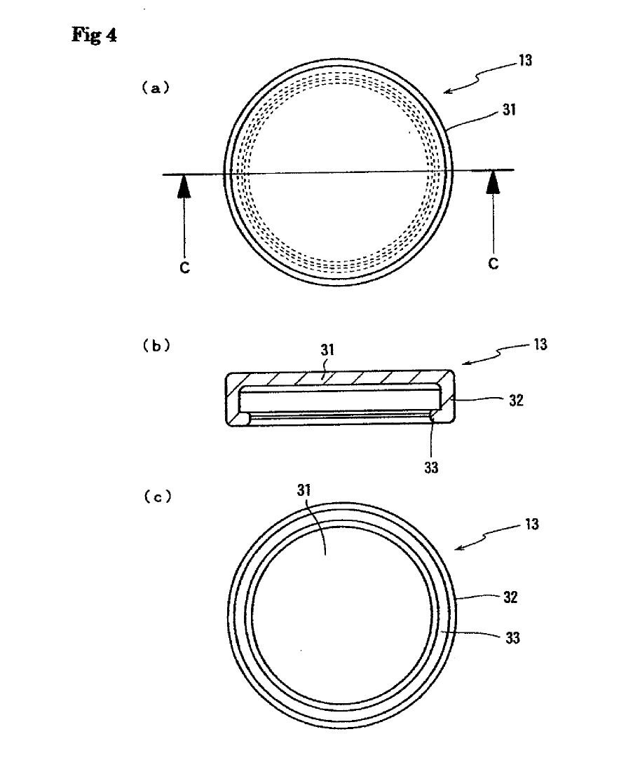

FIG. 1 to FIG. 4 are drawings showing a first embodiment of a wall mounting device according to the present invention. FIG. 1 (a) is a plan drawing of the wall mounting device. FIG. 1 (b) is a cross-section drawing along the A-A line of the wall mounting device shown in FIG. 1 (a). FIG. 1 (c) is a bottom-view drawing. FIG. 1 (d) is a side-view drawing. FIG. 2 shows a needle member used in the wall mounting device shown in FIG. 1. FIG. 2 (a) is a front-view drawing. FIG. 2 (b) is a side-view drawing. In addition, FIG. 3 shows a head member of the wall mounting device shown in FIG. 1. FIG. 3 (a) is a top-view drawing. FIG. 3 (b) is a cross-section drawing along the B-B line of the head member shown in FIG. 3 (a). FIG. 3 (c) is a bottom-view drawing. Furthermore, FIG. 4 is a drawing showing a cap used in the wall mounting device shown in FIG. 1. FIG. 4 (a) is a top-view drawing. FIG. 4 (b) is a cross-section drawing along the C-C line of the cap shown in FIG. 4 (a). FIG. 4 (c) is a bottom-view drawing.

In the first embodiment of the wall mounting device according to the present invention shown in FIG. 1, a wall mounting device 10 is equipped with: a metallic needle member 11 that is formed from stainless steel or the like; a resin bead member 12 that is combined with the needle member 11 so that the needle member 11 is outwardly projected from the head member; and a cap 13 that covers the head member 12. An engagement piece (wall-side metal piece) to which a wall-mounted object is engaged is mounted on a wall using the wall mounting device 10. In addition, an engagement piece (not shown in the drawing) to which a wall-mounted object is engaged can be secured to the head member 12 when the needle member 11 is driven into a wall.

As shown in FIG. 2, the needle member 11 in the first embodiment is formed from: two elongate plate-shaped pins 14,15; and a base section 16 continuous with and shared by the plate-shaped pins 14, 15. The two plate-shaped pins 14, 15, which are extended parallel to each other and in the same direction from the base section 16, are formed with the same height and are separated by a gap 20 having a width that is substantially the same as the width of the plate-shaped pins 13 and 14 (the gap in the example is slightly narrower than the width of the pins but the present invention is not restricted to this). The two plate-shaped pins 14, 15 and the base section 16 are arranged so that they all lie on the same plane. As shown in FIG. 2, the plate-shaped pins 14, 15 are formed with rounded sections where they meet the base section 16, preventing the pins from breaking off when they are pushed into or driven into a wall.

The end sections 21, 22 of the plate-shaped pins 14, 15 are formed as same triangular projections, i.e., as simple, tapered triangular shapes with narrowed ends. The end sections 21, 22 are tapered in this manner to allow the plate-shaped pins 14,15 to be easily pushed into walls. The end sections 21,22 of the plate-shaped pins 14, 15 can be tapered and formed with narrow ends using the same thickness as the main body of the pins. However, it would be preferable for the thickness of the pins to decrease toward the pointed ends as shown in FIG. 1 (d) and FIG. 2 (b) so that they can be pushed into walls more easily. Thus, the end sections 21, 22 of the plate-shaped pins 14, 15 are tapered toward the pointed ends to form long, sharp, plate-shaped pins that are narrow and thin, and this results in the driving force applied when the pins are driven into a wall being concentrated at the tapered end sections 21, 22 of the plate-shaped pins 14, 15. This provides a wedging action that allows the pins to be easily pushed into a wall even if the wall is made from a hard material such as concrete. Furthermore, the plate-shaped pins 14,15 are formed with thin, flat cross-sections so that the deformation and displacement of the concrete wall is small when the pins are driven in, thus minimizing damage to the concrete wall.

The needle member 11 is produced by punching a single metal plate, preferably a stainless steel plate, to form a plate-shaped element that includes a central base section, corresponding to the base section 16, and two plate-shaped pins 14,15 continuous with and extending from the base section. In this case, the needle member 11, ranging from the base section 16 to the end sections 21, 22 of the plate-shaped pins 14, 15, is formed with a uniform thickness. However, performing a pressing operation during or after the punching operation can provide the configuration of the first embodiment shown in the drawings wherein the thickness is uniform for the section up to the end sections 21, 22, including the base section 16, while the thickness of the end sections 21, 22 decreases gradually toward the pointed ends. It would also be possible to have the thickness decrease gradually from the base section 16 to the pointed ends of the end sections 21, 22. With the plate-shaped pins structured in this manner, the end sections 21,22 are formed narrow and with the least thickness, thus allowing the pins to be easily driven into walls. This makes the pins suited for use on walls formed from relatively soft materials, e.g., plasterboard, as well.

As shown in FIG. 1 and FIG. 3, the head member 12 is formed from resin in the shape of a stepped cylindrical block. More specifically, the head member 12 is equipped with a block-shaped main unit section 25 and a head end section 26 that is provided integrally and in front of the main unit section 25, the head end section 26 having an outer diameter that is larger than that of the main unit section 25. The head member 12 is formed with a slit 27 extending along a diameter of the cylinder and passing through the main unit section 25 and the head end section 26. The slit 27 serves as a support/guide groove that supports the needle member 11 combined with the head member 12 and that guides the movement of the needle member 11 as the needle member 11, starting from this supported state, is pushed through the head member 12 and driven into a wall. As a result, the slit 27 has an inner wall with a shape corresponding to the cross-section shape of the base section 16 of the needle member 11 and through which the needle member 11 can pass. However, rather than allowing the needle member 11 to pass through the slit 27 freely, it would be preferable for there to be a certain amount of compression fitting so that there is resistance to movement of the needle member 11, thus providing support for the needle member 11 without allowing it to move around freely. With this configuration, the needle member 11 can be combined with the head member 12 to be packaged and sold as a set. Even when this type of resistance is provided, the needle member 11 can be made to move relative to the head member 12 by applying a driving force that exceeds this resistance.

FIG. 4 shows a detailed view of the cap 13. The cap 13 is formed from an easily deformable resin. The cap 13 is equipped with: a top plate section 31; a circular side section 32 that is integrally connected to the outer edge of the top plate section 31; and a ring-shaped engagement section 33 that is integrally formed with and extends inwardly from the free end of the circular side section 32. The cap 13 is attached to the head member 12 by being placed over the head end section 26 and engaging the engagement section 33 with the step section between the main unit section 25 and the head end section 26.

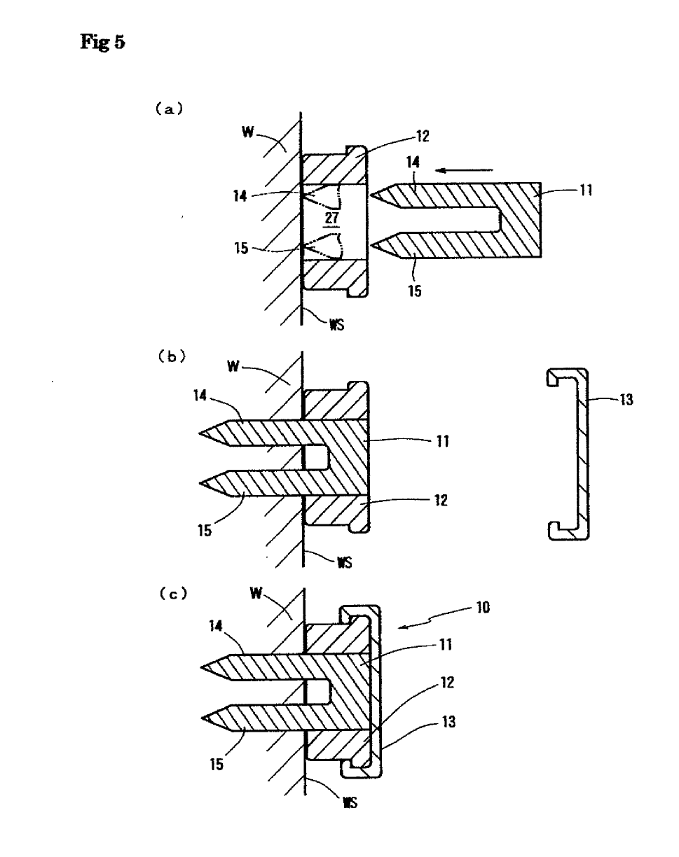

FIG. 5 shows the wall mounting device 10 from FIG. 1 to FIG. 4 mounted to a surface WS of a wall W. First, as shown in FIG. 5 (a), the head member 12 is placed at a certain position on the surface WS of the wall W. Then, from this state, the needle member 11 is inserted into the slit 27 of the head member 12. Since the slit 27 provides frictional resistance against the motion of the needle member 11, a tool such as a hammer is used to strike the base section 16 of the needle member 11 and drive the needle member 11 through the slit 27 of the head member 12 and into the wall W. During this operation, the motion of the needle member 11 in the head member 12 is guided by the slit 27 so that the needle member 11 is prevented from becoming buckled, deformed, warped, or the like if there is resistance from the wall W. The slit 27 also serves as a pin guiding hole that acts as a guide when the plate-shaped pins 14, 15 pass through. As shown in FIG. 5 (b), the needle member 11 is driven in until the tool strikes the head end section 26, i.e., the back surface of the base section 16 is level with the surface of the head end section 26. In this state, almost all of the plate-shaped pins 14, 15 are thrust into the wall W. Finally, the cap 13 is used to cover the head member 12, completing the mounting of the wall mounting device 10 to the wall Was shown in FIG. 5 (c). As a result, the guidance provided by the slit 27 of the head member 12 prevents the attitude of the needle member 11 from changing as it is being driven in, even if the wall W is made from a relatively hard material such as concrete, thus allowing the needle member 11 to be reliably mounted in a stable manner with the correct direction. Once the needle member 11 is driven in, the wall W press against the plate-shaped pins 14,15 from both sides so that friction prevents the plate-shaped pins 14, 15 from slipping out from the wall W, thus providing a stronger connection to the wall W. It would also be possible to provide the needle member 11 as a set with the head member 12, with the needle member 11 being inserted partially into the slit 27 of the head member 12 (e.g., with the end section of the needle member 11 at the position indicated by the dotted lines in FIG. 5 (a)). In this case, the base section 16, projected from the head member 12, of the needle member 11 would be struck with a tool to drive the needle member 11 into the wall W while the slit 27 acts as a guide.

The hanging force resulting from hanging a wall-mounted object using this wall mounting device 10 is divided between the two plate-shaped pins 14, 15 and applied to the wall W, thus allowing the object to be supported in a stable manner by the wall W. In addition, if the needle member 11 is driven into the wall W while its attitude is unstable, the lateral instability will result in larger holes in the wall W that will reduce the support strength of the driving pins. However, since each of the two parallel plate-shaped pins 14, 15 are driven into the wall W while being guided by the head member 12, a stable attitude is provided and the holes formed in the wall W can be kept as small as possible. The shapes of the end sections 21, 22 of the plate-shaped pins 14, 15 described above are examples and the present invention is not restricted to these shapes. The thickness of the plate-shaped pins 14, 15 can be modified as appropriate, e.g., a uniform thickness or tapered toward the pointed end, depending on the hardness of the mounting wall, e.g., hard walls such as concrete walls or walls made from relatively soft materials such as plasterboard.

### Second Embodiment

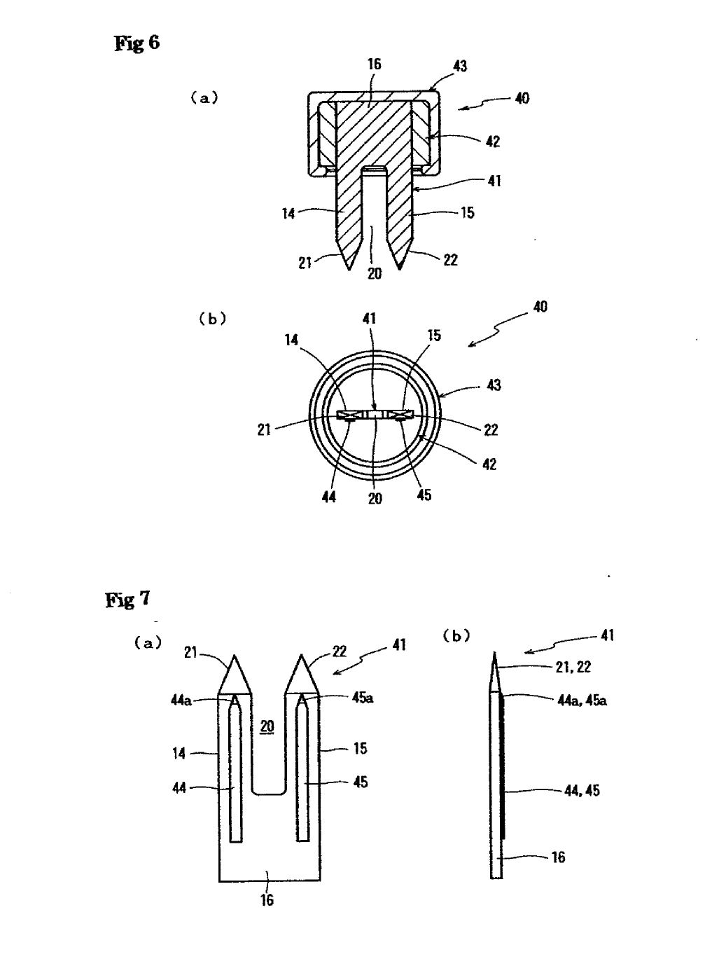

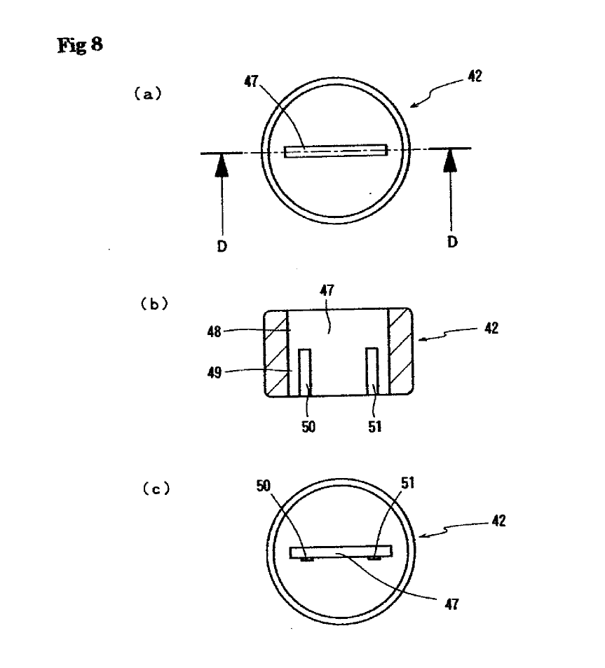

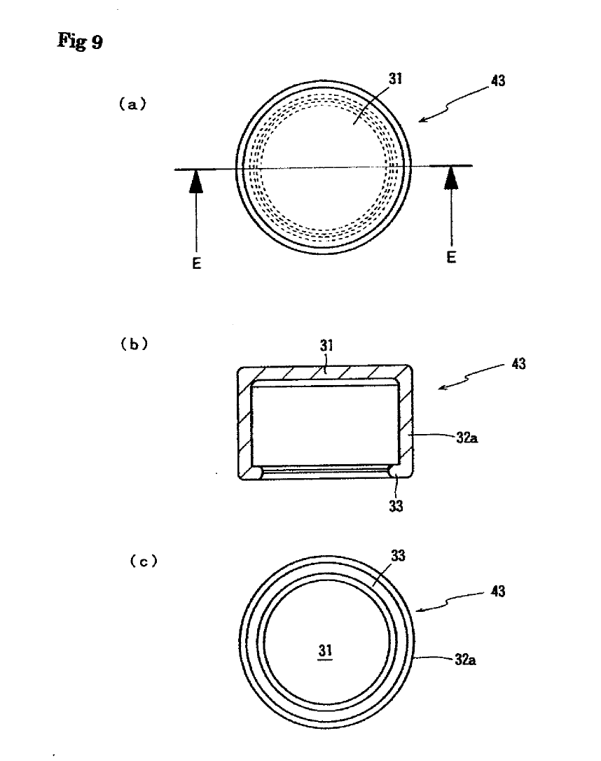

FIG. 6 to FIG. 9 show another embodiment of the wall mounting device according to the present invention. FIG. 6 shows a second embodiment of the wall mounting device according to the present invention. FIG. 6 (a) is a vertical cross-section drawing. FIG. 6 (b) is a bottom-view drawing. FIG. 7 shows a needle member used in the wall mounting device shown in FIG. 6. FIG. 7 (a) is a front-view drawing. FIG. 7 (b) is a side-view drawing. FIG. 8 shows a head member used in the wall mounting device shown in FIG. 6. FIG. 8 (a) is a top-view drawing. FIG. 8 (b) is a vertical cross-section drawing along the D-D line at the central position in FIG. 8 (a). FIG. 8 (c) is a bottom-view drawing. FIG. 9 shows a cap used in the wall mounting device shown in FIG. 6. FIG. 9 (a) is a top-view drawing. FIG. 9 (b) is a vertical cross-section drawing along the E-E line at the central position in FIG. 9 (a). FIG. 9 (c) is a bottom-view drawing. In the description of the second embodiment, members and parts providing equivalent functions in structures identical to those from the first embodiment are labeled using the same numerals as in the first embodiment and redundant descriptions are omitted.

In the second embodiment of the wall mounting device according to the present invention shown in FIG. 6, a wall mounting device 40 is equipped with: a needle member 41 that is formed from stainless steel or the like; a resin head member 42 with which the needle member 41 is combined by being inserted through the head member 42; and a cap 43 that covers the head member 42. As in the first embodiment, an engagement piece (wall-side metal piece) to which a wall-mounted object is engaged is mounted on a wall using the wall mounting device 40. In addition, an engagement piece (not shown in the drawings) to which a wall-mounted object is engaged can be secured to the head member 42 with the needle member 41 being driven into the wall.

As shown in FIG. 6 (b) and FIG. 7, the plate-shaped pins 14, 15 of the needle member 41 are formed with ribs 44, 45 extending respectively along the longitudinal axes thereof on one side of the elongate plates. The ribs 44, 45 extend in a straight line along the longitudinal axes of the plate-shaped pins 14, 15, stopping before the end sections 21, 22 of the plate-shaped pins 14, 15 (i.e., the ribs extend to a position corresponding to where tapering begins), and also extend to a position corresponding to half the height of the base section 16. Other aspects of the structure are the same as those of the needle member 11 from the first embodiment. The ribs 44, 45 can be easily shaped with a pressing operation performed during the production of the needle member 41. As in the needle member 11 shown in the first embodiment, the end sections 21, 22 of the needle member 41 are formed in a tapered shape with a narrow end that is thinner toward the pointed end.

In general, the elongate plate-shaped pins 14, 15 have the least rigidity against bending forces around an axis that is perpendicular to the longitudinal axis and that extends coplanar with the plate shape of the pins (i.e., flexes in a direction perpendicular to the plate surface when taking a view along the longitudinal direction). By forming the ribs 44, 45 on the surface of the elongate plates, the strength and the rigidity of the plate-shaped pins 14, 15 projecting from the base section 16 are improved, making it possible to provide a structure that prevents bending or buckling when the pins are struck or pushed into a wall. Smooth tapers 44a, 45a are formed on the ends of the ribs 44, 45 toward the end sections 21, 22.

FIG. 8 shows the head member 42 used in the wall mounting device 40. The head member 42 is made ahead of time from resin and is shaped, overall, as a cylindrical block. The head member 42 is formed at the center with a slit 47 that passes through the head member 42, i.e., that extends along a diameter of the cylinder. The slit 47 serves as a support/guide groove that guides the movement of the needle member 41 and also serves as a pin guide groove that guides the plate-shaped pins 14, 15 when the needle member 41 moves. The slit 47 is defined by inner walls in which an area 48 is formed with half the height of the base section 16 of the needle member 41 and a shape that corresponds to the cross-section shape of the base section 16, and an area 49, provided in the remaining area, is formed with concave grooves 50, 51 corresponding to the ribs 44, 45. Rather than allowing the needle member 41 to pass through the slit 47 freely, it would be preferable for there to be a certain amount of compression fitting so that there is resistance to movement of the needle member 41, thus providing support for the needle member 41 to prevent it from moving around randomly. With this configuration, the needle member 41 can be combined with the head member 42 to be packaged and sold as a set. Even when this type of resistance is provided, the needle member 41 can be made to move relative to the head member 42 by applying a driving force that exceeds this resistance.

As a result, when the needle member 41, which is equipped with the plate-shaped pins 14, 15 formed with the ribs 44, 45, is driven through the slit 47 from the area 48 side, the ribs 44, 45 move forward while pushing apart the area 48 of the slit 47 with guidance provided by the tapers 44a, 45a, thus allowing the needle member 41 to be driven into the wall W while being guided by the slit 47. Then, once the needle member 41 has been driven into the wall W to a predetermined depth, the ribs 44, 45 of the plate-shaped pins 14,15 fit into the concave grooves 50, 51 and the base section 16 is positioned in the areas 48, 49 of the slit 47. As a result, the end of the base section 16 does not project from the end surface of the head member 42 and instead is positioned to form a level surface (the state shown in FIG. 6 (a)).

FIG. 9 shows the cap 43 used in the wall mounting device 40. The cap 43 is shaped and structured to cover the entire surface of the head member 42, with the exception of the end surface from which the plate-shaped pins 14,15 of the needle member 41 project. In other words, except for the circular side section 32a being longer, the cap 43 is identical to the cap 13 of the first embodiment.

### Third Embodiment

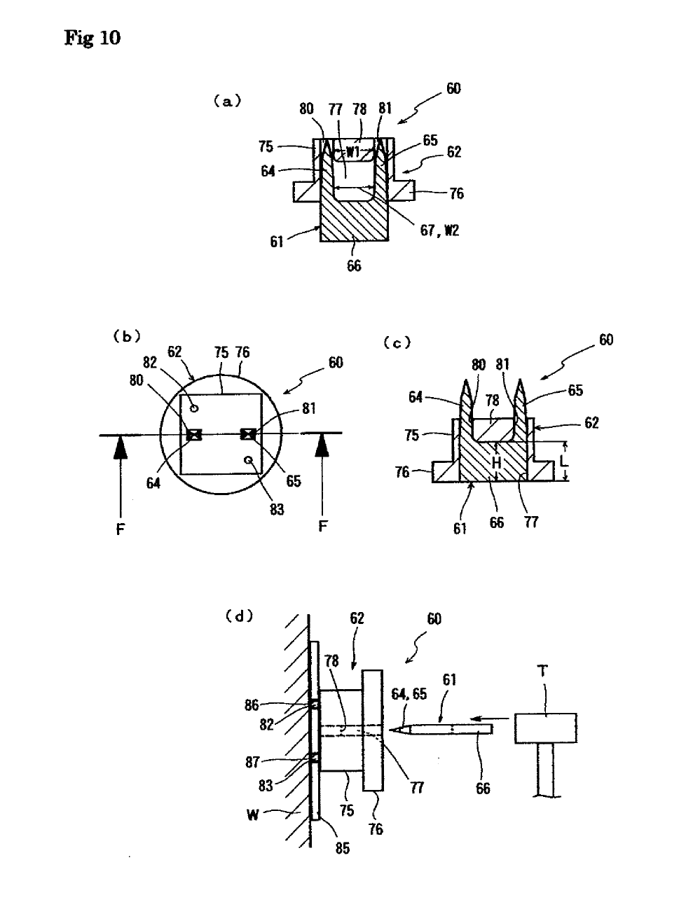

FIG. 10 shows a third embodiment of the wall mounting device according to the present invention. FIG. 10 (a) is a cross-section drawing of the wall mounting device with a section of the needle member pushed into the slit. FIG. 10 (b) is a plan drawing showing the wall mounting device with the needle member pushed into the slit. FIG. 10 (c) is a cross-section drawing along the F-F line in FIG. 10 (b). FIG. 10 (d) shows the wall mounting device of this embodiment when it is driven into a wall. In the third embodiment shown in FIG. 10 of the wall mounting device according to the present invention, the mounting device 60 is equipped with: a metal needle member 61; and a resin head member 62 with which a needle member 61 is combined by being inserted through the head member 62. The mounting device 60 is equipped with a cap that covers the head member 62 but the description thereof will be omitted since a structure equivalent to that of the cap 13 shown in the first embodiment can be used.

In the mounting device 60 according to the third embodiment shown in FIG. 10, the needle member 61 is equipped with plate-shaped pins 64, 65 and a base section 66. In the needle member 61 of the third embodiment, a gap 67 between the plate-shaped pins 64, 65 is set up to be wider than the gap 20 between the plate-shaped pins 14, 15 in the first embodiment. In the head member 62, a head end section 76 is formed as a short cylinder as in the head end section 26 of the first embodiment. Unlike the cylindrical main unit section 25 in the first embodiment, however, a main unit section 75 is formed in a box shape. The slit 77 extends through the head member 62 and is provided as a support/guide groove that guides the motion of the needle member 61 through the main unit section 75 and the head end section 76. A stopper section 78 is formed by filling a part of the slit 77 on the main unit section 75 side and is provided to prevent the needle member 61 from moving a predetermined amount or greater in the driving direction. The width W1 of the stopper section 78 corresponds to the width W2 of the gap 67 between the plate-shaped pins 64, 65. As shown in FIG. 10 (c), the heights of the stopper section 78 and the base section 66 are set up so that when the needle member 61 is driven into the wall W to a predetermined depth, the base section 66 runs into the stopper section 78 and the end surface of the base section 66 becomes level with the end surface of the head end section 76 of the head member 62. More specifically, the length L between the stopper surface of the stopper section 78 and the end surface of the head end section 76 is set up to be equivalent to the height H of the base section 66.

The needle member 61 was developed as a pin for concrete walls, where strength is necessary. Thus, in this example, a shape suited for driving into concrete walls is used, with the base section 66 having a greater height and the plate-shaped pins 64, 65 being formed narrower toward the pointed ends. Of course, the needle member can also be used for softer, non-concrete walls, e.g., mortar walls. In the needle member 61, the plate-shaped pins 64, 65 are narrowed with tapered widths and, in order to make the needle member even easier to drive into hard walls, e.g., concrete walls, the thickness is also gradually tapered to provide pointed ends as in the needle member 11 shown in FIG. 2. However, it would also be possible to keep the thickness uniform. The needle member 61 is made by performing a pressing operation, followed by a quenching operation (the resulting hardness varies according to the quenching temperature). The material used for the needle member 61 can be, for example, carbon tool steel (SK steel) or 65 Mn spring steel. For relatively soft concrete walls, stainless steel (SUS301) or the like can be used. In addition, the head member 62 can be formed from a hard resin.

The slit 77 is divided by the stopper section 78, with pin guide holes 80, 81 being formed on either side of the stopper section 78 to serve as parts of the support/guide groove to guide the motion of the plate-shaped pins 64, 65. By forming the head member 62 ahead of time with the pin guide holes 80, 81 for guiding the plate-shaped pins 64, 65, the motion of the plate-shaped pins 64, 65 can be guided by the pin guide holes 80, 81 when the plate-shaped pins 64, 65 are driven into a wall. This prevents the plate-shaped pins 64, 65 from buckling and allows the pins to move smoothly relative to the head member 62.

FIG. 10 (d) illustrates how the mounting device 60 is mounted to the wall W. First, a plate-shaped assisting abutment piece 85 made from metal or resin is placed on the wall W where the mounting device 60 is to be mounted. As shown in FIG. 10 (b), bosses 82, 83 are formed at opposite corners of the end surface of the main unit section 75 of the head member 62, while the assisting abutment piece 85 is formed with boss holes 86, 87 corresponding to the bosses 82, 83. By providing the bosses 82, 83 and the boss holes 86, 87 in this manner, the head member 62 of the mounting device 60 can be aligned to the assisting abutment piece 85 by fitting the bosses 82, 83 formed on the head member 62 to the boss holes 86, 87 formed on the assisting abutment piece 85. From this state, a tool T is used to drive the needle member 61 through the slit 77 formed in the head member 62. This allows the needle member 61 to be driven through the assisting abutment piece 85 and into the wall W at a predetermined mounting position while being guided by the head member 62. The assisting abutment piece 85 can be formed with a hole or the like ahead of time at the position where the needle member 61 will pass through. If the assisting abutment piece 85 is not used, there is no need to form the bosses 82, 83 on the main unit section 75 of the head member 62, and the needle member 61 can be driven into the wall W by placing the head member 62 directly against the wall W. If the needle member 61 is to be driven in with the head member 62 directly placed against the wall W, positioning of the head member 62 can be achieved by attaching two-sided tape to the side of the head member 62 that comes into contact with an object (the wall W), thus making it easier to drive the needle member 61 into the wall W. In addition, damage to the wall W can be prevented and the holes remaining in the wall W alter removal of the needle member 61 can be minimized. The use of two-sided tape when the assisting abutment piece 85 is placed against the wall W also allows the assisting abutment piece 85 to be positioned relative to the object (wall W) and allows the needle member 61 to be easily driven into the wall W. Here also, damage to the concrete forming the wall can be prevented and the holes remaining in the wall W after removal of the needle member 61 can be minimized.

### Fourth Embodiment

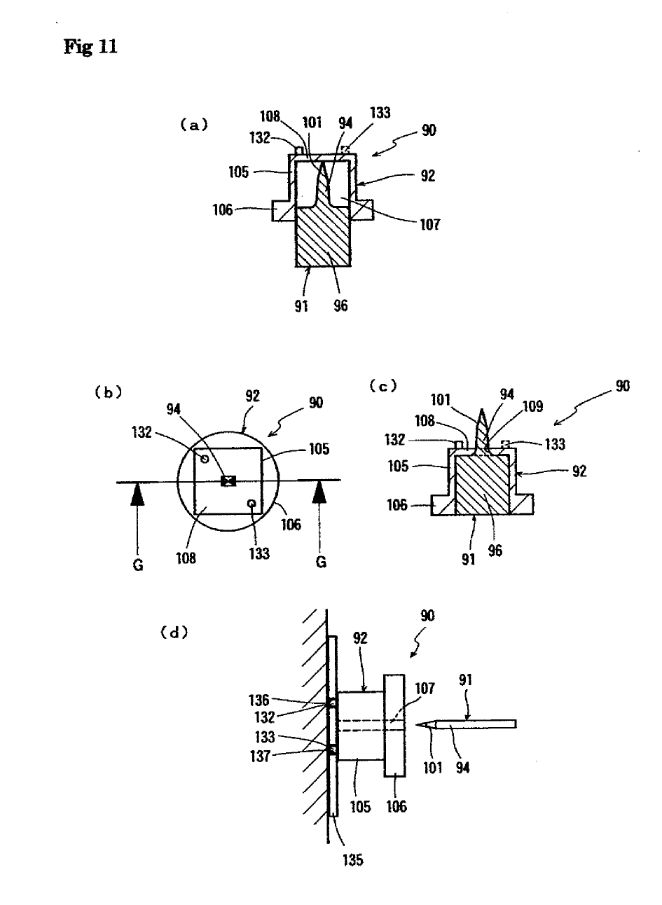

FIG. 11 shows a fourth embodiment of the wall mounting device according to the present invention. FIG. 11 (a) is a cross-section drawing showing the wall mounting device with a portion of the needle member pushed into the slit. FIG. 11 (b) is a plan drawing showing the wall mounting device with the needle member pushed into the slit. FIG. 11 (c) is a cross-section drawing along the G-G line in FIG. 11 (b). FIG. 11 (d) shows how the wall mounting device according to this embodiment is driven into the wall. In the fourth embodiment, a wall mounting device 90 is equipped with: a metal needle member 91; and a resin head member 92 with which a needle member 91 is combined by being inserted through the head member 92. The mounting device 90 is equipped with a cap that covers the head member 92 but the description thereof will be omitted since a structure equivalent to that of the cap 13 shown in the first embodiment can be used. As in the needle member 61 shown in FIG. 10, the needle member 91 was developed as a pin for concrete walls, where strength is necessary. Thus, in this example, a shape suited for concrete walls is used, with a base section 96 being formed with a greater height and a plate-shaped pin 94 being formed narrower toward the pointed end. Of course, the needle member can also be used for softer, non-concrete walls, e.g., mortar walls.

In the wall mounting device 90 of the fourth embodiment shown in FIG. 11, the needle member 91 is equipped with the single plate-shaped pin 94 and the base section 96. The plate-shaped pin 94 extends from a central position of the base section 96. As in the third embodiment, the head member 92 is equipped with a box-shaped main unit section 105 and a short, cylindrical head end section 106. The head member 92 is provided with a slit 107 that serves as a support/guide groove, the end thereof being sealed by a thin wall 108 through which the plate-shaped pin 94 of the needle member 91 passes through. When the needle member 91 is driven in, the base section 96 of the needle member 91 is guided by the slit 107 and the driving force is concentrated at the end section 101 of the plate-shaped pin 94 so that an opening is formed in the thin wall 108. This results in forming a hole 109 in the thin wall 108 through which the plate-shaped pin 94 passes through. This hole 109 then serves as a guide hole that guides the plate-shaped pin 94 as the needle member 91 is driven in further while the base section 96 is guided to the slit 107. When the base section 96 reaches the thin wall 108, the needle member 91 cannot be driven in further. Thus, the thin wall 108 also serves as a stopper that stops the needle member 91. In the example shown in the figure, the thin wall 108 at the end of the head member 92 is not formed with a hole. However, if the plate-shaped pin 94 of the needle member 91 is large or the thin wall 108 is relatively thick, a hole for passing through the plate-shaped pin 94 can be formed ahead of time in the thin wall 108 as needed. As shown in FIG. 11 (d), the wall mounting device 90 is driven into the wall W in the same manner as in FIG. 10 (d). More specifically, bosses 132, 133 are formed at opposite corners of the end surface of the head member 92, while an assisting abutment piece 135 that is placed between the head member 92 and the wall W is formed with boss holes 136, 137 corresponding to the bosses 132, 133. The structure and usage of the assisting abutment piece 135 is equivalent to the structure and usage of the assisting abutment piece 85 shown in FIG. 10 (d), so redundant descriptions will be omitted.

### Fifth Embodiment

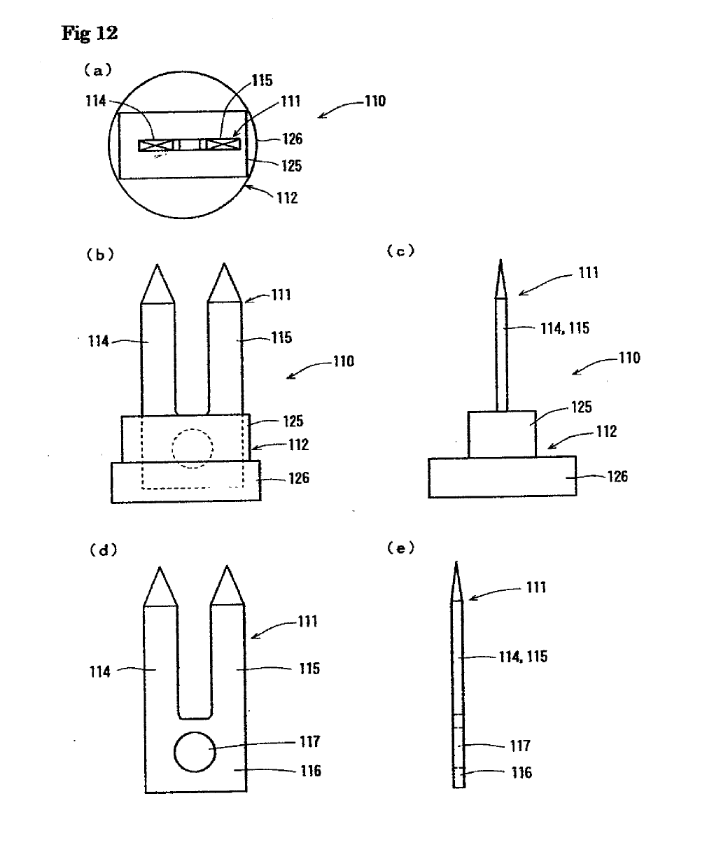

FIG. 12 shows a fifth embodiment of the wall mounting device according to the present invention. FIG. 12 (a) is a plan drawing showing the needle member and the head member of the wall mounting device. FIG. 12 (b) is a front-view drawing of FIG. 12 (a). FIG. 12 (c) is a side-view drawing of FIG. 12 (a). FIG. 12 (d) is a front-view drawing of the needle member by itself. FIG. 12 (e) is a side-view drawing of FIG. 12 (d). In the fifth embodiment, a wall mounting device 110 is equipped with: a metal needle member 111 that is formed from stainless steel or the like; and a resin head member 112 that is combined with the needle member 111 so that the needle member 111 is outwardly projected.

As in the needle member 11 in the first embodiment, the needle member 111 in the fifth embodiment is equipped with two plate-shaped pins 114, 115 and a base section 116 shared by the pins 114,115. The head member 112 is equipped with a main unit section 125 and a head end section 126. The needle member 111 is insert-molded integrally with the head member 112 so that the base section 116 is embedded in the head member 112. Alternatively, it would be possible to embed the base section 116 so that it is exposed at the surface of the head member 112. When driving the needle member 111 into a hard wall, a tool such as a hammer is used to strike the head end section 126 of the head member 112. By forming the base section 116 integrally with the head member 112 by performing injection molding of resin accompanied by insert-molding, the metal needle member 111 can be easily and firmly secured to the head member 112.

In particular, a blanking hole 117 is formed in the base section 116 of the needle member as shown in FIG. 12 (d). In the example shown in the figure, a single relatively large hole is formed. However, other arrangements can be used, e.g., two relatively small holes can be formed side by side. By providing this type of hole 117, the injected resin can flow into the hole 117 when insert molding is performed with the needle member 111. The flow of resin into the hole 117 during insert molding bonds the resin and the needle member 111, resulting in a significantly stronger bond between the needle member 111 and the head member 112. In addition, ribs can be formed on the plate-shaped pins 114, 115 as illustrated in the second embodiment to increase the contact area between the plate-shaped pins 114, 115 and the resin. More specifically, the lower sections of the ribs extending to the base section 116 of the needle member 111 are embedded in the resin along with the base section 116. This not only provides increased strength where the plate-shaped pins 114, 115 are projected from the resin but also further increases the strength of the bond between the needle member 111 and the bead member 112.

### Sixth Embodiment

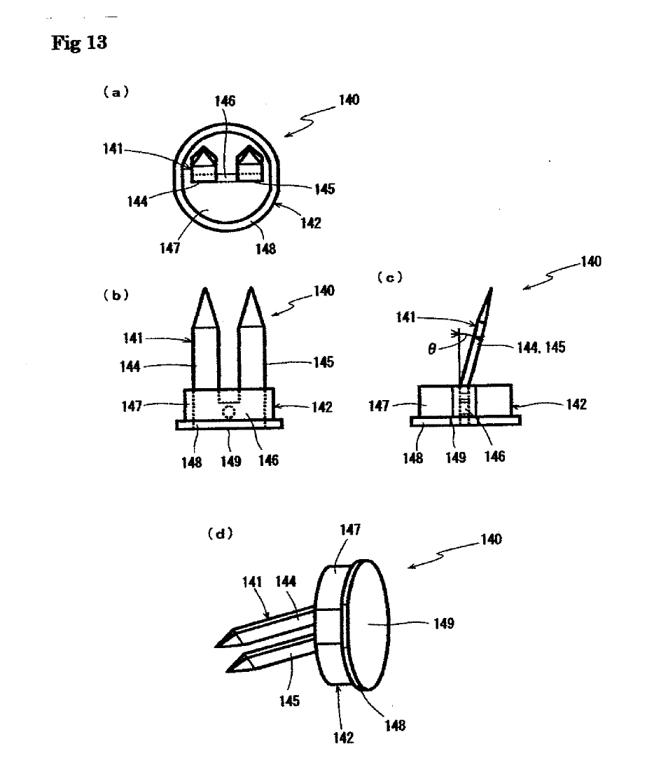

FIG. 13 shows a sixth embodiment of the wall mounting device according to the present invention. FIG. 13 (a) is a plan drawing showing a needle member and a head member of the wall mounting device. FIG. 13 (b) is a front-view drawing of FIG. 13 (a). FIG. 13 (c) is a side-view drawing of FIG. 13 (a). FIG. 13 (d) is a perspective drawing of the wall mounting device. In the sixth embodiment, a wall mounting device 140 is equipped with: a metal needle member 141 that is formed from stainless steel or the like; and a resin head member 142 that is combined with the needle member 141 so that the needle member 141 is projected from one side.

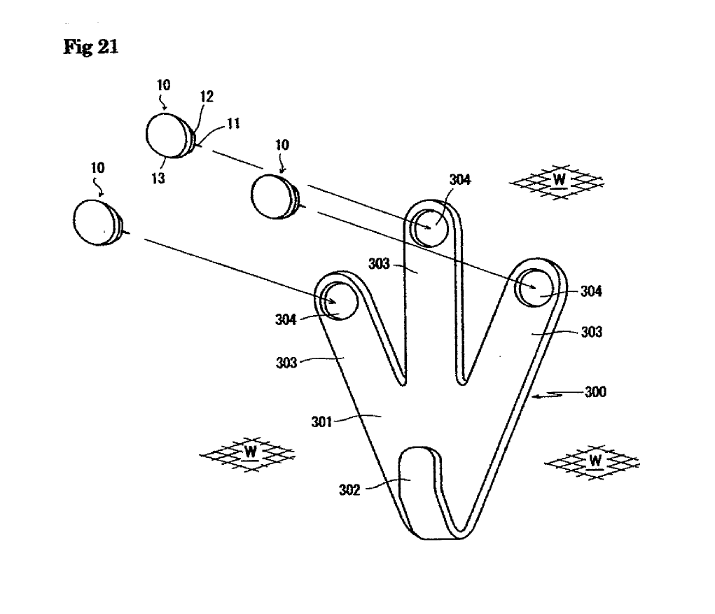

In the sixth embodiment, the needle member 141 is equipped with plate-shaped pins 144, 145 that include pointed end sections (similar to the end sections 21, 22 of the needle member 11 in the wall mounting device 10 of the first embodiment); and a base section 146 shared by the pins 144,145. The head member 142 is equipped with: a main unit section 147; and a head end section (flange section) 148 that is integral with the main unit section 147. The needle member 141 is insert-molded integrally with the head member 142 so that the base section 146 is embedded in the head member 142. The plate-shaped pins 144, 145 are arranged so that all or most; excluding a section toward the base section 146, of the pins are projected from the head member 142. By forming the base section 146 integrally with the head member 142 by performing insert molding, the metal needle member 141 is firmly secured to the head member 142. If the wall is soft, the wall mounting device 140 can be pushed in by hand. For hard walls, a tool such as a hammer is used to drive a head end section 149 (see FIG. 21 (d)) of the head member 142 into the wall.

In the sixth embodiment, the plate-shaped pins 144, 145 project from the head member 142 and extend diagonally relative to the head member 142, bending sharply at the positions where the pins 144,145 just project. The two plate-shaped pins 144, 145 are sloped in the same direction. When using the wall mounting device 140, it would be preferable for the wall mounting device 140 to be driven into the wall so that the ends of the plate-shaped pins 144, 145 extend diagonally downward. When the weight of an object, e.g., furniture, is applied to the wall mounting device 140 so that the object is supported, this configuration results in the wall mounting device 140 receiving a force in a direction that thrusts the wall mounting device 140 against the wall W (see FIG. 15), causing the needle member 141 to be pushed deeper into the wall W. As a result, the wall mounting device 140 is prevented from slipping out from the wall W. The slope angle θ (see FIG. 13 (c)) of the plate-shaped pins 144, 145 is generally approximately 15 deg, but other angles (e.g., approximately 25 deg) can be used as appropriate depending on how the object is supported, the hardness of the wall, and the like.

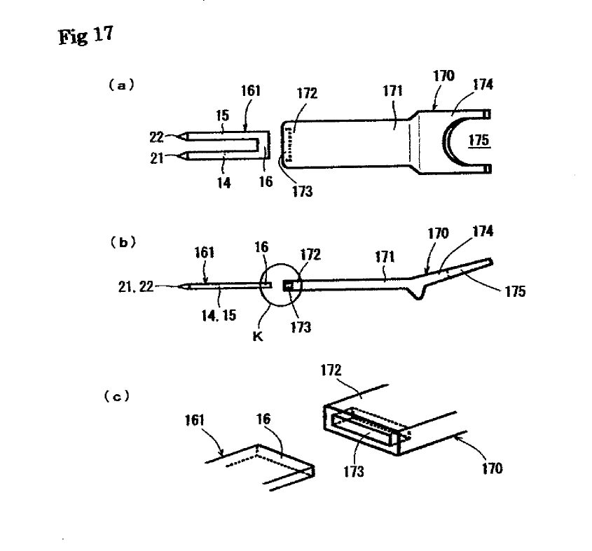

Structures used in the other embodiments, e.g., the structure for inserting and supporting the plate-shaped pins to the head member and the use of ribs on the plate-shaped pins, can be used and combined as appropriate for the wall mounting device 140 of the sixth embodiment. For example, the needle member 141 can be passed through the head member 142 and driven into a wall, wherein a cap is mounted to cover the back surface of the base end of the needle member 141 while the needle member 141 is inserted through the head member 142. In addition, it would be possible to form the surface of the elongate plates of the plate-shaped pins 144, 145 with ribs that extend along the longitudinal axes of the plate-shaped pins 144, 145. Furthermore, it would be possible to form the needle member 141 so that its thickness gradually decreases toward the tip. Rather than a circle, the outer perimeter of the head member 142 is formed in a shape similar to an ellipsis, with the sides being cut flat. This shape allows a pushing aid (FIG. 17) to be engaged with the flat side sections so that the wall mounting device 140 can be easily removed from the wall. This feature will be described in detail later.

### Seventh Embodiment

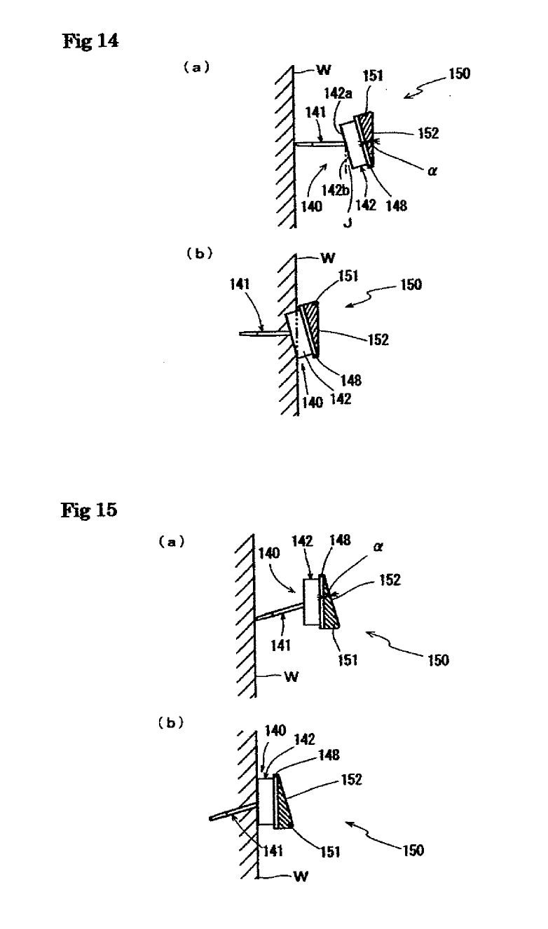

FIG. 14 shows a seventh embodiment formed by modifying a portion of the wall mounting device shown in FIG. 13. FIG. 14 (a) is a side-view drawing showing the initial stage of the driving in of the wall mounting device. FIG. 14 (b) is a side-view drawing showing the wall mounting device after it has been driven in completely. A wall mounting device 150 shown in FIG. 14 is formed by providing an assisting unit 151, which provides head shape correction, on the head end section 148 of the head member 142 in the wall mounting device 140 shown in FIG. 13. The assisting unit 151 has a wedge-shaped cross section with an angle α. This angle α is based on the slope angle θ of the needle member 141 (α=θ). By attaching this assisting unit 151, the head shape is corrected so that an outer end surface 152 of the assisting unit 151 is perpendicular to the longitudinal direction of the needle member 141, thus allowing the wall mounting device 150 to be easily driven into the wall W. For example, the wall mounting device 150 shown in FIG. 14 is used by driving the needle member 141 into the wall W horizontally. In this case, the end surface 152 of the assisting unit 151 provides a pushing surface that is perpendicular to the horizontal driving direction of the horizontally oriented needle member 141. When the outer end surface 152 is pushed by hand in the case of a soft wall W, or driven in with a tool such as a hammer in the case of a hard wall W, the driving force can be concentrated in the direction in which the needle member 141 extends, thus allowing the needle member 141 to be easily driven into the wall W.

When the needle member 141 of the wall mounting device 150 is driven into the wall W with the assisting unit 151 attached in this manner, the end surface of the head member 142 facing the wall W is not parallel to the surface of the wall W. As a result, when an upper section 142a of the head member 142 is abutted against the wall W, a gap J is formed between a lower section 142b of the head member 142 and the surface of the wall W, as indicated by the dotted line in FIG. 14 (a). However, since the needle member 141 is sloped at an angle of approximately 15 deg, driving the wall mounting device 150 forcefully into the wall W can push the head member 142 into the wall W and eliminate the gap J between the lower section 142b and the wall W, as shown in FIG. 14 (b). This allows the wall mounting device 150 to be reliably mounted to the wall W.

FIG. 15 shows another way in which the wall mounting device shown in FIG. 14 can be used. FIG. 15 (a) is a side-view drawing showing the initial stage of the driving in of the wall mounting device. FIG. 15 (b) is a side-view drawing showing the wall mounting device after it has been driven in completely. The wall mounting device 150 shown in FIG. 15 has the same structure as the wall mounting device 150 shown in FIG. 14 but differs from FIG. 14 in that it is driven into the wall W with the needle member 141 sloped diagonally downward. More specifically, the head member 142 is used with the same attitude that would be used in a wall mounting device in which the needle member is not sloped relative to the head member (e.g., as in the embodiment shown in FIG. 1). Since the outer end surface 152 of the assisting unit 151 is perpendicular to the direction of the needle member 141, the driving force resulting from pushing the end surface 152 by hand or using a hammer is concentrated in the direction of the needle member 141, thus allowing the needle member 141 to be easily driven into the wall W diagonally. As shown in FIG. 15 (a), when the wall mounting device is used in this manner, the needle member 141 is driven diagonally downward into the wall W in the direction of the slope of the needle member 141. When the needle member 141 of the wall mounting device 150 is driven into the wall W, the head member 142 is parallel to the wall W when it abuts the wall W, and no gap is formed between the head member 142 and the surface of the wall W, as shown in FIG. 15 (b). Thus, the wall mounting device 150 can be reliably mounted to the wall W. As in the description above relating to the sixth embodiment shown in FIG. 13, when the weight of an object, e.g., furniture, is applied to the wall mounting device 150 so that the object is supported, this configuration results in the wall mounting device 150 receiving a force in a direction that thrusts the wall mounting device 150 against the wall W, causing the needle member 141 to be pushed deeper into the wall W. As a result, the wall mounting device 150 is prevented from slipping out from the wall W.

### Eighth Embodiment

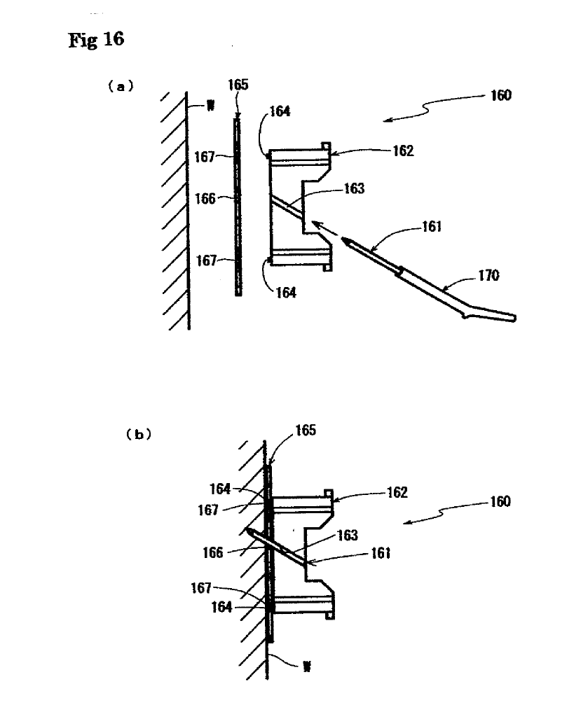

FIG. 16 shows a different embodiment of the wall mounting device with a diagonal needle member. FIG. 16 (a) is an exploded diagram of the eighth embodiment of the wall mounting device according to the present invention. FIG. 16 (b) is a drawing showing the wall mounting device as it is being mounted to a wall. A wall mounting device 160 according to the eighth embodiment is equipped with: a needle member 161 that is straight; and a head member 162 that is formed with a slit 163 into which the needle member 161 is inserted, the slit 163 being straight but extended diagonally. When mounting the wall mounting device 160 to a wall, a plate-shaped assisting abutment piece 165 similar to the assisting abutment piece 85 shown in FIG. 10 (d) is first placed on the side of the head member 162 toward the wall W. The needle member 161 inserted through the slit 163 is passed through a center hole 166 formed on the assisting abutment piece 165 and driven into the wall W. This mounts the head member 162 to the wall W by way of the assisting abutment piece 165. Once mounted, the needle member 161 is driven deep into the wall W as shown in FIG. 16 (b). Bosses 164, 164, which are projected from the head member 162, are fitted to corresponding alignment boss holes 167, 167 formed on the assisting abutment piece 165 to align the head member 162 relative to the assisting abutment piece 165. With this wall mounting device 160 of the eighth embodiment, the needle member 161 is pushed from behind to drive it into the wall W, but driving the wall mounting device into the wall W by hand may hurt the user's fingers. For this reason, in the eighth embodiment, the needle member 161 is driven into the wall W using a mounting assistance tool 170 that serves as a pushing aid. The rear end of the needle member 161 is fitted into the tip of the mounting assistance tool 170 so that the needle member 161 is supported by the mounting assistance tool 170. By gripping the mounting assistance tool 170 and pushing the needle member 161 along with the mounting assistance tool 170 into the head member 162, it is possible to easily push the needle member 161 through the head member 162 and the assisting abutment piece 165 and into the wall W. In FIG. 16, the needle member 161 is inserted diagonally upward. However, it would also be possible, of course, to provide a mounting tool with the needle member inserted diagonally downward as shown in FIG. 15. In this configuration, the application of the weight of the object contributes to thrusting the wall mounting device against the wall W, thus preventing the wall mounting device from slipping out of the wall as described above.

FIG. 17 shows detailed illustrations of the pushing aid, i.e., the mounting assistance tool 170. FIG. 17 (a) is a plan drawing of the mounting assistance tool and the needle member. FIG. 17 (b) is a side-view drawing of the same. FIG. 17 (c) is a perspective drawing that provides a detailed view of section K in FIG. 17 (b). The needle member 161 can be a needle member that is equivalent to the needle member 11 shown in FIG. 2. The elements of the needle member 161 will be assigned like designators as those used in the needle member 11, and redundant descriptions will be omitted. In the mounting assistance tool 170, an end section 172 of a main unit 171 that is gripped by the user is formed with a cavity section 173 that extends inward from the end. The mounting assistance tool 170 is made to support the needle member 161 by pushing the base section 16 of the needle member 161 into the cavity section 173 to provide a compression fit. By operating the mounting assistance tool 170 with the needle member 161 supported at the end section 172 of the mounting assistance tool 170, it is possible to push the needle member 161 into the slit 163 of the head member 162 without hurting fingers or hands. In the mounting assistance tool 170 shown in FIG. 17, the base section 16 of the needle member 161 is supported by forming the cavity section 173. However, it would so be possible to form the cavity section 173 as a groove that is cut to extend to side surfaces.

In addition, the head member 142 shown in FIG. 13 is formed in a non-circular shape, e.g., by cutting sections of the outer perimeter flat as described above. A fitting cavity 175, formed on a rear end section 174 of the mounting assistance tool 170, opens outward and is shaped to complement the non-circular shape of the head member 142. When the wall mounting device 140 is in a state driven into the wall, the fitting cavity 175 of the mounting assistance tool 170 can be fitted to the non-circular bead member 142 and the mounting assistance tool 170 can be manipulated so that a disengagement force can be applied to the wall mounting device 140 in an effective manner and the wall mounting device 140 can be easily removed from the wall.

### Alternative Example

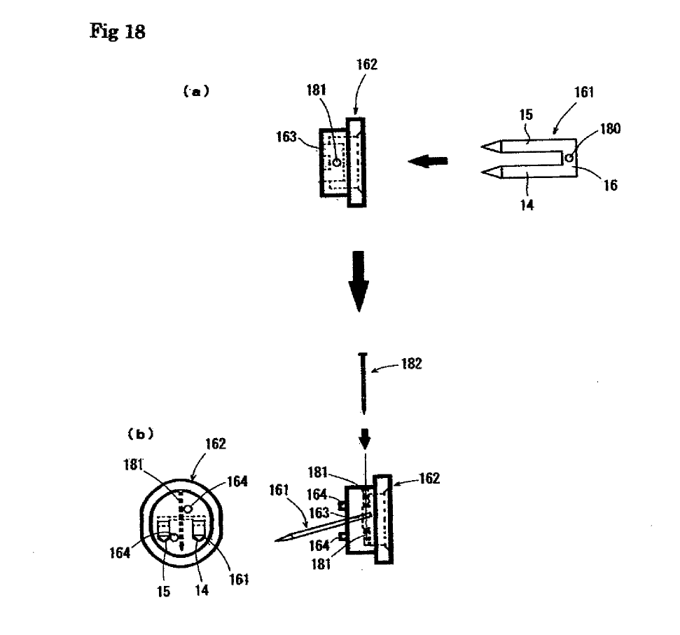

FIG. 18 shows an alternative example of the eighth embodiment shown in FIG. 16. In the example shown in FIG. 18, the needle member 161 pushed into the head member 162 is prevented from slipping out of the head member 162. More specifically, in the needle member 161, the center portion of the base section 16 is formed with a hole 180 into which a slip-prevention pin, described later, can be inserted. The head member 162 is also formed with holes 181,181 into which the slip-prevention pin, described later, can be inserted. The holes 181, 181 are formed on either side of the slit 163 at positions corresponding to those of the hole 180 of the needle member 161 when it is pushed into the slit 163. When using this wall mounting device, the needle member 161 is first inserted into the slit 163 of the head member 162, as shown in FIG. 18 (a). When the needle member 161 is completely pushed into the head member 162, the hole 180 of the needle member 161 is aligned with the holes 181, 181 of the head member 162 as shown in FIG. 18 (b). From this state, a slip-prevention pin 182 is inserted from the one hole 181 of the head member 162 through the hole 180 of the needle member 161 and the other hole 181 of the head member 162. As a result, the needle member 161 is secured to the head member 162 and the needle member 161 is prevented from slipping out of the head member 162 when the wall mounting device is driven into the wall.

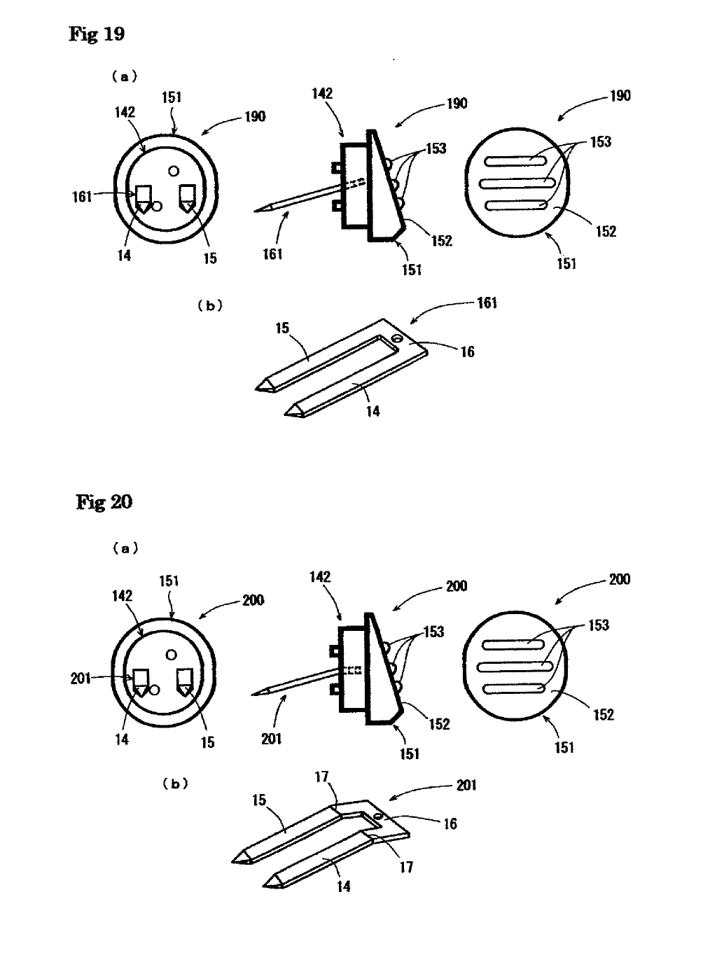

FIG. 19 and FIG. 20 show other alternative examples of the wall mounting devices shown in FIG. 14 and FIG. 15 as the seventh embodiment (and an alternative example thereof). In the example shown in FIG. 19, a wall mounting device 190 uses a straight needle member 161 as in the eighth embodiment. In the example shown in FIG. 20, a wall mounting device 200 uses a needle member 201 formed with an angled shape, i.e., the plate-shaped pins 14, 15 are formed with bends at intermediate points (toward the base section 16, e.g., at the positions indicated by bend lines 17, 17). In both examples, the plate-shaped pins 14, 15 of the needle member 161 and 201 are projected diagonally from a central position on the end surface of the head member 142 facing the wall, and the projected sections are straight. More specifically, in the case of the wall mounting device 200 shown in FIG. 20, the needle member 201 projects from the end surface of the head member 142 at the bend lines 17, 17. In the wall mounting devices 190, 200 shown in FIG. 19 and FIG. 20, the needle members 161, 201 are formed integrally with the head members 142 through insert molding and the slip-prevention pin 182 in the example shown in FIG. 18 is not used. The end surface 152, which is struck with a tool, of the assisting unit 151 to be attached to the head member 142 is formed with a plurality of parallel, rib-shaped slip preventers 153.

### [Usage Example of the Wall Mounting Device]

FIG. 21 shows one usage example of the wall mounting device according to the present invention (e.g., the wall mounting device 10 shown in the first embodiment). In FIG. 21, three wall mounting devices 10, 10, 10 are used to secure a metal hook piece 300 to the wall W. The metal hook piece 300 is equipped with: a main unit 301; a hook section 302 that is formed by bending back the lower end of the main unit 301; and three arm sections 303, 303, 303 extending from the main unit 301. The end section of each arm section 303 is formed with a hole 304 through which the wall mounting device 10 is driven. Each hole 304 is formed as a circle to accommodate the head member 12 of the wall mounting device 10. The metal hook piece 300 is secured to the wall W by driving the needle members 11 of the wall mounting devices 10 through the holes 304 and into the wall W. This allows objects such as coat hangers or handbags to be hooked to and hung from the hook section 302. The metal piece secured to the wall W in FIG. 21 is presented as an example and it would be possible to use other shapes and configurations not shown in the drawings. Besides being used to assist in hooking objects, it is clear that the present invention can also be used to secure to the wall W a wall mounting device that can engage with an adapter for attaching a support or other product or with a furniture-side metal piece that is attached to furniture.

### [Other]

The wall mounting device according to the present invention is used to attach an object to a wall. The wall can be a standard residential mortal wall, wooden wall, veneer panel wall, or a concrete wall. Wall materials formed from wood or veneer panel can, of course, include in addition to solid natural wood: plywood overlaid with decorative veneer, in which a thin wooden panel is attached to a base material such as plywood or MDF (medium-density fiberboard); synthetic resin plywood, in which the resin-treated paper or vinyl is adhered to the surface of plywood; and printed plywood, in which wood grain or the like is printed directly onto plywood. Examples of plaster walls include diatomaceous plaster walls, which provide a high degree of odor reduction, and plaster made from slaked lime. The present invention can also be used with gypsum plaster and dolomite plaster walls.

With regard to the shape of the plate-shaped pins, driving pins equipped with plate-shaped pins that become gradually thinner toward the tip are suited for use in plasterboard and mortar walls. With regard to the embodiments other than those shown in FIG. 10 and FIG. 11, plate-shaped pins with substantially uniform widths are suited as needle members to be used in soft walls such as walls formed from plasterboard or wood. Plate-shaped pins can be formed with a pointed end that is thinner at the end section. With soft walls, the thickness at the end section can be reduced without leading to breakage when the needle member is driven into the wall.

With hard walls such as concrete walls, the length, width, and thickness of the portion of the plate-shaped pin extending from the base section to the end section can be modified as appropriate according to the method of usage as long as damage, e.g., breakage or bending, does not result, although this depends on the material and processing methods used. Plate-shaped pins formed with gradually decreasing widths such as those in the embodiments shown in FIG. 10 and FIG. 11 are suited for use in needle members for concrete walls. This type of needle member can, of course, be used in soft walls such as plasterboard and wood walls as well. En addition to using thick pins to provide stability and prevent damage, it is also possible to decrease the thickness at the end section. The use of pins with ribs provides increased strength and rigidity, which increases resistance to deformation and buckling. As an example, pins can be formed with a length of approximately 17 mm, a distance (gap) between pins of 2 to 6 mm, and a thickness of 0.8 mm to 2.0 mm. These dimensions are simply examples, however, and it would be preferable to determine the characteristics of the driving pins by taking into account the weight of the object to be attached, the type of wall material (e.g., hardness), the number of driving pins to be used, the load that will be applied on each of the driving pins, and the like. For example, the thickness of the plate-shaped pins can be greater for harder walls. Thus, it would be preferable to prepare driving pins with various specifications so that it is possible to select pins with specifications that are safe for specific usages.

### LIST OF DESIGNATORS

10, 40, 60, 90, 110, 140, 150, 160, 190, 200: wall mounting device
11, 41, 61, 91, 111, 141, 161, 201: needle member
12, 42, 62, 92, 112, 142, 162: head member
13, 43: cap
14, 15, 64, 65, 94,114, 115, 144, 145: plate-shaped pin
27, 47, 77, 107, 163: slit (support guide groove)
44, 45: rib
78: stopper section
80, 81: pin guide hole
108: thin wall (stopper section)
109: guide hole
151: assisting unit
153: slip preventer
180, 181: hole for slip prevention pin
182: slip prevention pin

1. A wall mounting device that is equipped with a plate-shaped needle member and a head member with which said needle member is combined so that said needle member is outwardly projected from the head member, said needle member being driven into a wall so that said head member is mounted on said wall, wherein:
said needle member is equipped with a base section and at least one elongate plate-shaped pin with a pointed end section, said elongate plate-shaped pin being extended from said base section,
said head member is formed with a support/guide hole that supports said combined needle member and that guides the motion of said needle member in the direction in which said needle member is driven in when said needle member is driven from said supported state through said head member and into said wall,
said support/guide hole includes a slit which has an inner wall with a shape corresponding to the cross-section shape of said base section of said needle member and guides the motion of said base section in the direction in which said needle member is driven in until said needle member is driven into said wall.

2.-4. (canceled)

5. A wall mounting device according to claim 1 wherein: said head member is provided with a stopper section that blocks motion of said needle member in the direction in which said needle member is driven in.

6.-7. (canceled)

8. A wall mounting device according to claim 1 wherein: a cap that covers a back surface of said needle member is mounted to said head member when said needle member has been driven through said head member.

9. (canceled)

10. A wall mounting device according to claim 1 wherein: said plate-shaped pins with said pointed end sections of said needle member extend from said base section and are formed as at least two parallel pins arranged along a single plane.

11. A wall mounting device according to claim 1 wherein: a rib is formed on a surface of an elongate and flat plate of said plate-shaped pin, said rib extending along a longitudinal axis of said plate-shaped pin.

12. A wall mounting device according to claim 1 wherein: said plate-shaped pin is formed either with a uniform thickness from said base section to said end section or with a thickness that gradually decreases when going from said base section to said end section.

13. A wall mounting device according to claim 1 wherein: said plate-shaped pin is extended with a diagonal slope relative to said head member.

14. A wall mounting device according to claim 13 wherein: said needle member is either: a straight needle member that is formed with no bend in said plate-shaped pin and that is extended with a diagonal slope relative to said head member; or an angled needle member that is formed with a bend at an intermediate position along said longitudinal axis of said plate-shaped pin, said bent section being extended with a diagonal slope relative to said head member.

15. A wall mounting device according to claim 13 wherein: said head member is provided with an assisting unit that includes an end surface that corrects the shape of said head member on the basis of a slope angle of said plate-shaped pin, said end surface being perpendicular to a direction in which the plate-shaped pin extends.

16. A wall mounting device according to claim 15 wherein: said wall mounting device is either driven in with said plate-shaped pin at a direction that is perpendicular to said wall or driven in with said plate-shaped pin being sloped relative to said wall and with said head member not being sloped relative to said wall.

17. A wall mounting device according to claim 15 wherein: a plurality of slip prevention ribs is formed on an end surface of said assisting unit to which a pressing force is applied when said wall mounting device is driven into said wall.

18. A wall mounting device according to claim 1 wherein: a wall-mounted object is directly engaged to said head member; or said wall-mounted object is indirectly engaged to said head member by way of a securing piece that is secured to said head member.
